(19) United States
(12) Patent Application Publication
(10) Pub. No.: US 2025/0033515 A1
(43) Pub. Date: Jan. 30, 2025

(54) METHOD OF CONTROLLING DRIVING OF ADS VEHICLE BY AVDS AND APPARATUS FOR CONTROLLING DRIVING OF ADS VEHICLE BY AVDS

(71) Applicant: HYUNDAI MOBIS CO., LTD., Seoul (KR)

(72) Inventor: Jae Yong LEE, Seoul (KR)

(73) Assignee: HYUNDAI MOBIS CO., LTD., Seoul (KR)

(21) Appl. No.: 18/767,617

(22) Filed: Jul. 9, 2024

(30) Foreign Application Priority Data
Jul. 28, 2023 (KR) 10-2023-0098858
Jul. 28, 2023 (KR) 10-2023-0098859

(51) Int. Cl. B60L 53/66; B60L 53/65; B60W 60/00

(52) U.S. Cl. CPC B60L 53/665; B60L 53/65; B60W 60/0025; B60W 2400/00

(57) ABSTRACT

A processor-implemented method including identifying a subject vehicle (SV), performing a check-in for the SV, and performing an autonomous vehicle operation for the SV by an automated valet driving system (AVDS).

### CROSS-REFERENCE TO RELATED APPLICATIONS

This application claims the benefit of Korean Patent Application No. 10-2023-0098858, filed on Jul. 28, 2023 and Korean Patent Application No. 10-2023-0098859, filed on Jul. 28, 2023, the entire disclosures of which are incorporated herein by reference for all purposes.

### BACKGROUND

### 1. Field

Embodiments relate to a method and apparatus for performing automated valet driving.

### 2. Description of the Related Art

An automated valet driving system (AVDS) includes a user, a system, and an autonomous vehicle. The AVDS may transfer autonomous driving control authority from a user to the autonomous vehicle. The AVDS may perform valet driving control using an autonomous driving function. An efficient control method, data transmission/reception method, etc. are required for the AVDS to perform valet driving by controlling a vehicle.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, here is provided a processor-implemented method including identifying a subject vehicle (SV), performing a check-in for the SV, and performing an autonomous vehicle operation for the SV by an automated valet driving system (AVDS).

The performing the autonomous vehicle operation may include calculating, by the AVDS, a traveling start time of the SV based on an expected charging completion time of a vehicle at a target charging station.

The calculating may include receiving, by the AVDS, information from one or more charging stations and calculating, by the AVDS, a reference value for determining the target charging station from among the one or more charging stations based on the information, the information may include one or more of charging time information, charging rate information, charging type information, and AVDS usage information of vehicles being charged or reserved for charging at the one or more charging stations, and the reference value may be one or more of an expected return time of the SV, an expected charging rate of the SV, and an expected arrival time at which the SV arrives at the one or more charging stations.

The calculating may include determining whether the vehicle corresponds to an AVDS vehicle responsive to the expected return time of the SV corresponding to the reference value, and, when the vehicle corresponds to the AVDS vehicle, the AVDS may calculate the expected return time of the SV based on one or more of a time at which the SV arrives at the target charging station, an expected charging time of the SV, and a return time of the SV.

The calculating may include determining, by the AVDS, the target charging station from among the one or more charging stations based on priority information of a user, and the priority information may include one or more of charging rate information, charging station brand information, and illuminance information from when the SV moves.

The performing the autonomous vehicle operation may include initiating, by the AVDS, driving of the SV to the target charging station responsive to the traveling start time being reached, and the traveling start time may be derived by the AVDS based on the expected charging completion time or a time before the expected charging completion time.

The performing the autonomous vehicle operation may include driving, by the AVDS, the SV to a waiting parking area responsive to the SV arriving at the target charging station before a charging of the vehicle is completed, or driving, by the AVDS, the SV to a charging area responsive to the SV arriving at the target charging station after charging of the vehicle is completed.

The performing the autonomous vehicle operation further may include transmitting, by the AVDS, escape information to the target charging station responsive to the SV moving from the waiting parking area to the charging area responsive to the SV is in waiting parking area and transmitting, by the AVDS, entry information to the target charging station responsive to the SV entering the charging area, the escape information including one or more of an identification ID of the waiting parking area, a time at which the SV enters the waiting parking area, and a target charging station management number of the SV and the entry information including one or more of an identification ID of the charging area, a time at which the SV enters the charging area, and the target charging station management number of the SV.

The method may include transmitting and receiving data for the autonomous vehicle operation by the AVDS.

The data transmitted by the AVDS may include one or more of vehicle information for the SV, charging reservation information, vehicle departure information, payment schedule type information, charging type availability information, charging reservation availability information, and charging rate information, and the data received by the AVDS may include one or more of charging type availability information, charging reservation availability information, and charging rate information.

The data received by the AVDS may include one or more of currently available charging type information, charging reservation information, and charging rate information and the data transmitted by the AVDS may include one or more of charging reservation confirmation information, expected vehicle arrival time information, payment method information, payment information, and vehicle information.

In a general aspect, here is provided an automated valet driving device (AVDS) including a processor configured to execute instructions and a memory storing the instructions, an execution of the instructions configures the processor to identify an SV, perform a check-in for the SV, and perform an autonomous vehicle operation for the SV by the AVDS.

The autonomous vehicle operation may include calculating a traveling start time of the SV based on an expected charging completion time of a vehicle at a target charging station and transmitting and receiving data for the autonomous vehicle operation by the AVDS.

In a general aspect, here is provided a vehicle including an interface configured to exchange information with an AVDS, a controller configured to control automated valet driving, a processor, associated with the controller and interface, the processor being configured to execute instructions, and a memory storing the instructions, and an execution of the instructions configures the processor to perform an autonomous vehicle operation by the AVDS.

The autonomous vehicle operation may include calculating a traveling start time based on an expected charging completion time of a vehicle at a target charging station and performing automated valet driving according to data transmitted and received by the AVDS.

### BRIEF DESCRIPTION OF THE DRAWINGS

FIG. 1 illustrates a basic flow of an AVDS according to embodiments.

FIG. 2 illustrates a system structure related to a method/apparatus according to embodiments.

FIG. 3 illustrates a vehicle control device according to embodiments.

FIG. 4 illustrates a structure of a vehicle according to embodiments.

FIG. 5 illustrates a timeline of traveling of an AVDS-based vehicle to an electric vehicle (EV) charging station according to embodiments.

FIG. 6 illustrates an automated valet driving method according to embodiments.

FIG. 7 illustrates an automated valet driving method according to other embodiments.

FIG. 8 illustrates an automated valet driving method according to still other embodiments.

FIG. 9 illustrates an EV charging station based on the AVDS according to embodiments.

FIG. 10 illustrates an automated valet driving method according to embodiments.

Throughout the drawings and the detailed description, unless otherwise described or provided, the same, or like, drawing reference numerals may be understood to refer to the same, or like, elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Advantages and features of the present disclosure and methods of achieving the advantages and features will be clear with reference to embodiments described in detail below together with the accompanying drawings. However, the present disclosure is not limited to the embodiments disclosed herein but will be implemented in various forms. The embodiments of the present disclosure are provided so that the present disclosure is completely disclosed, and a person with ordinary skill in the art can fully understand the scope of the present disclosure. The present disclosure will be defined only by the scope of the appended claims. Meanwhile, the terms used in the present specification are for explaining the embodiments, not for limiting the present disclosure.

Terms, such as first, second, A, B, (a), (b) or the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

Throughout the specification, when a component is described as being “connected to,” or “coupled to” another component, it may be directly “connected to,” or “coupled to” the other component, or there may be one or more other components intervening therebetween. In contrast, when an element is described as being “directly connected to,” or “directly coupled to” another element, there can be no other elements intervening therebetween.

In a description of the embodiment, in a case in which any one element is described as being formed on or under another element, such a description includes both a case in which the two elements are formed in direct contact with each other and a case in which the two elements are in indirect contact with each other with one or more other elements interposed between the two elements. In addition, when one element is described as being formed on or under another element, such a description may include a case in which the one element is formed at an upper side or a lower side with respect to another element.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

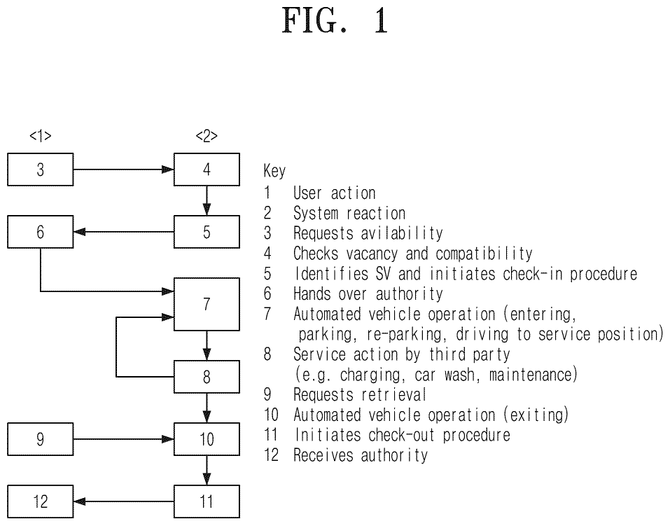

FIG. 1 illustrates a basic flow of an AVDS according to embodiments.

FIG. 1 illustrates a basic flow of an AVDS. The AVDS is extension of a use case of ISO 23374-1 automated valet parking system (AVPS) and an operational design domain (ODD). This system contributes to realization of safe and reliable low-speed Level 4 unmanned driving of a vehicle, and promotes fast and smooth introduction of a future L4 system to a market based on experience gained using the AVDS at low speed in a well-defined ODD.

The AVDS provides a low-speed automatic valet parking service to a vehicle owner. The service is not limited to driverless driving within dedicated parking facilities and allows driverless driving in designated outdoor spaces. Basically, both the AVPS and the AVDS describe a journey from a point A to a point B.

One example use case addressed by the AVDS is valet parking in an airport terminal. The AVPS describes SAE L4 driving in a dedicated parking facility, while the AVDS extends a drop-off area to areas outside the parking facility. After a driver leaves a designated local AVDS drop-off area, the system automatically guides a vehicle on a public road to an entrance to the parking facility and guides the vehicle to an empty parking space or another space as necessary from the entrance. Referring to a space of interest, for example, other use cases addressed by the AVDS may include driving cases at an electric charging station or a car cleaning station or on company premises for logistics purposes.

The AVDS is expected to achieve end-user benefits in terms of saving time, reducing stress, reducing energy consumption of the vehicle, and meet user expectations for a lot of low-speed maneuvering functions. The AVDS provides an automatic charging process for an electric vehicle without requiring a driver to invest time and optimizes utilization of the limited number of charging stations. The AVDS on company premises may reduce labor costs through an unmanned vehicle control system.

To contribute to realization of safe and reliable unmanned AVDS operation, requirements specified in this document are based on performance of state-of-the-art technology available at the time of publication. Therefore, this part will be revised in the future as technology improves.

Embodiments include specific technical solutions for communication interfaces (for example, communication methods and message protocols) due to differences in technologies (for example, spectrum allocation) that are available and commonly used worldwide. Therefore, the embodiments are linked to communication interfaces at national/regional level to ensure interoperability.

The AVDS performs Level 4 autonomous driving of an individual or a plurality of unoccupied vehicles at speeds less than 30 km/h within a defined operating area.

The embodiments designate system frameworks, operational sequences and communication interfaces, performance requirements for operation and management functions, environmental conditions within the operating area, and test procedures to verify performance requirements of the AVDS. The AVDS is considered a use case and ODD extension of ISO 23374-1, including indoor and outdoor applications, which are unmanned operation on company premises, driving on public roads, and outdoor valet parking (for example, from an airport terminal to a parking lot). In addition, the AVDS enables additional services. Further, the AVDS is applied to the cases of driving to electric vehicle charging stations or car washes.

The AVDS includes physically separate subsystems distributed among vehicles, facility equipment, and user domains. Functions of the AVDS are realized by the cooperation of these subsystems, which in most cases are provided by different organizations. The embodiments include a system architecture using subsystems and communication interfaces between subsystems at a logical level.

The AVDS manages system participants (for example, AVDS-compatible vehicles, facilities, and users) and provides necessary interfaces therebetween. The embodiments include requirements for management functions such as verifying compatibility between vehicles and premises, performing remote assistance and recovery when autonomous driving is impossible, and issuing shutdown commands in response to actions of other facility users.

In addition, the AVDS is intended to be used by service providers or facility operators receiving vehicle authorization from individual service recipients.

The embodiments may refer to the following standard documents.

ISO 23374-1, Intelligent transport systems—Automated valet parking systems (AVPS)—Part 1: System framework, requirements for automated driving, and communication interface

ISO 20900, Intelligent transport systems—Partially Automated Parking Systems (PAPS)—Performance Requirements and Test Procedures

ISO 8608 Mechanical vibration—Road surface profiles—Reporting of measured data

ISO 19206-2, Road vehicles—Test devices for target vehicles, vulnerable road users and other objects, for assessment of active safety functions—Part 2: Requirements for pedestrian targets

ISO 19206-4 Road vehicles—Test devices for target vehicles, vulnerable road users and other objects, for assessment of active safety functions—Part 4: Requirements for bicyclist targets.

Definitions of terms according to embodiments are as follows.

Service provider of AVDS: An organization that provides the AVDS to operate unmanned vehicles

User of AVDS: An individual service recipient who transfers/recovers rights (3.3) to/from a service provider through the AVDS

Authority: The right and ability to perform specific tasks in an SV

SV: A vehicle equipped with a vehicle operation subsystem of the AVDS

Premises: Public or private areas where the AVDS is available

Parking facility: A public or private parking lot with AVDS capability

Operation zone: A geographic area within an AVDS-compliant premises where automated driving may be performed

Drop-off area: A location within an operating area where a user leaves the SV and transfers authority to a service provider

Pick-up Area: A location within the operating area where a service provider transfers the SV for user boarding and hands over authority

Parking Spot: A destination within a work area where one vehicle may be parked or temporarily stored

Stopping point: A destination within a work area where the SV stops and remains under certain state conditions, depending on the considered use case

Parking area: An area within an operating area including a plurality of parking spaces

Destination: a location within a work area where the SV is to be transported

Route: A planned traversal of the SV from an origin to a destination

Path: A planned sequence of way points for the SV to follow

Trajectory: A planned route including time information, automated valet parking facility equipment

PFE: Physical equipment installed in parking facilities to support the AVPS, automated valet driving premises equipment

DPE: Physical equipment installed in an operating area of AVDS premises to support the AVDS

Coded marker: A physical or logical marker using a unique ID installed on the AVDS premises detectable by the SV to support localization

Anonymous marker: A physical or logical marker without a unique ID installed on the AVDS premises detectable by the SV to support localization

Designed speed: A situational speed of the SV designed for driving in a given situation (for example, a traffic situation and an environmental condition) as determined by the AVDS

Designed distance: A situational physical distance by design from the SV to other facilities, road users, objects or structures to be maintained by the AVDS in a given situation while performing autonomous driving

Subsystem: A logical level of AVDS component including one or more functions

Function: A function of the AVDS that contributes to processing inputs to the system and converting the inputs into appropriate outputs

(Autonomous driving service) reservation: Basic agreement between the user and the service provider with regard to the operation and management of the SV within a specific premises

(Automatic valet driving) session: An interaction sequence for a given SV between check-in and check-out

(Automatic valet driving) mission: A series of interactions in which the SV is automatically operated by the AVDS from a parking location to a destination for a specific purpose

(Test) scenario: A description of a complete traversal from an origin to a destination to be performed for testing

(Test) scene: A description of a specific event performed for a test, not including an origin or a destination

System operator (SO): A role of an organization that manages vehicle operations in an operation area of the AVDS premises, which includes tasks monitored while being automatically performed or manually performed by individuals from remote locations

Premises (PM): A role of an organization in maintaining a work area in an operable and safe condition in accordance with AVDS requirements

Orchestration system (OS): A system that classifies a session or several connected sessions into a single mission and arranges an executable and optimized sequence of such missions

Value added service system (VA): A role of a service system that provides dedicated service management and a communication interface to the AVDS

Definitions of abbreviations according to embodiments are as follows.

ADS (Automated Driving System), DDT (Dynamic Driving Task), OEDR (Object and Event Detection and Response), ODD (Operational Design Domain), SV (Subject Vehicle), FV (Forward Vehicle), PFE (automated valet Parking Facility Equipment), DPE (automated valet Driving Premises Equipment), VMC (Vehicle Motion Control), DSRC (Dedicated Short Range Communication), VRU (Vulnerable Road User), RO (Remote vehicle Operation (subsystem)), VO (on-board Vehicle Operation (subsystem)), UF (User Frontend (subsystem)), UB (User Backend (subsystem)), VB (Vehicle Backend (subsystem)), OB (Operator Backend (subsystem)), PM (automated valet Parking facility Management (subsystem)), DM (automated valet Driving premises Management (subsystem)), VA (value added service system)

FIG. 1 illustrates a basic flow of the AVDS based on a user action and a system response. FIG. 1 is a representative use case showing a flow in which a user initially transfers authority to a service provider.

In the AVDS, the user may request an additional service (for example, EV charging or car washing) to be performed while authority of the SV remains with the AVDS service provider. The requested service and earliest pickup time may be transferred to a system along with a reservation. While authority is previously with the AVDS service provider, an additional service may be requested depending on the remaining period.

These sessions, which include additional services, include more missions and tasks than those of the AVPS (for example, in the following order: park, wait, charge, park, wait, wash, and park). An orchestration system is in charge of sequencing the requested services and organizing the corresponding mission within a given time. Additional services are treated as additional missions, and the vehicle is driven to a designated location where the service is performed and the vehicle is re-parked at the original parking location or another location. Re-parking automatically occurs after the requested service is completed (for example, charging is completed, and car washing is completed), and there is a parking space available for the next service or re-parking. No user request is required. For each additional service, compatibility of the vehicle and service needs to be checked. This includes geometric (for example, vehicle height, width, length, and charging plug location), electrical (for example, plug type, charging power, and requested charging level) and other specific service characteristics.

Referring to FIG. 1, an AVDS service is provided according to <1> user action and <2> system reaction. An autonomous driving method and apparatus according to embodiments may correspond to a terminal for the user action and/or a system for the system reaction. The autonomous driving method and apparatus according to embodiments may be referred to as an automated valet driving method/device, or a method/device, etc. for brevity.

The method/apparatus according to embodiments receives a request from a user. The method/device according to embodiments checks empty space and compatibility for valet driving. The method/apparatus according to embodiments identifies an SV and activates a check-in process. The method/device according to embodiments receives autonomous driving authority from the user. The method/apparatus according to embodiments performs autonomous vehicle operation. For example, operations according to embodiments may include entering, parking, re-parking, and driving to a service position. The method/apparatus according to embodiments may selectively perform a service action by a third party. For example, there may be charging, car washing, maintenance, etc. The method/apparatus according to embodiments may allow the user to request collection. The method/apparatus according to embodiments may perform autonomous vehicle operations. For example, it is possible to perform exiting. The method/apparatus according to embodiments may activate a check-out procedure. The method/apparatus according to embodiments delivers authority to the user.

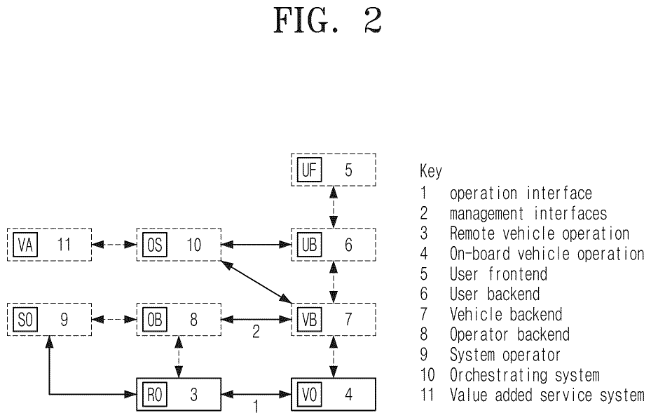

FIG. 2 illustrates a system structure associated with the method/apparatus according to embodiments.

FIG. 2 illustrates a system structure related to a method and apparatus for performing the basic flow of the AVDS of FIG. 1.

FIG. 2 is a logical structure of a subsystem of the AVDS. Implementation of logical subsystems with respect to a physical component may vary depending on the system design. In addition, the subsystem may include a plurality of physical components. For example, a remote vehicle operation subsystem may include a sensor, a control device, and a communication device.

Systems according to embodiments may perform and include methods/apparatus according to embodiments. For example, an AVDS device/system of the method/apparatus according to embodiments may include an operator backend (OB), an orchestrating system (OS), and/or remote vehicle operation (RO). The AVDS device/system according to embodiments may correspond to a server. A user terminal of the method/apparatus according to embodiments may include a user frontend (UF) and/or a user backend (UB). A vehicle of the method/apparatus according to embodiments may include a vehicle backend (VB) and/or on-board vehicle operation (VO). The system of the method/apparatus according to embodiments may further include a service system (value added service system, VA) and/or a system operator (SO). An operation according to embodiments may be performed by each component of the system of FIG. 2. Each component of FIG. 2 may correspond to hardware, software, processor, and/or a combination thereof.

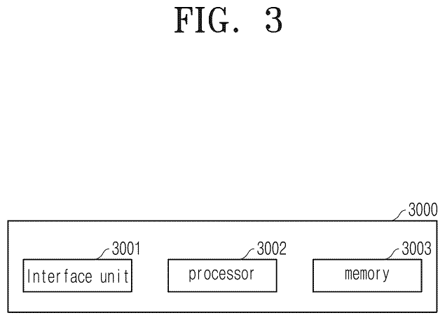

FIG. 3 illustrates a vehicle control device according to embodiments.

The vehicle control device 3000 according to embodiments is a device that controls an operation of a vehicle according to embodiments. The vehicle control device may be referred to as an autonomous driving integrated controller 600. The vehicle control device may include an interface unit 3001, a processor 3002, and a memory 3003.

The memory may store instructions, signaling information, data, etc. for performing operations according to embodiments. The memory may be connected to the interface unit and the processor to transmit and receive necessary signals.

The interface unit may receive signals, information, data, etc. received from the vehicle control device and transmit the signals, information, data, etc. to the memory and/or the processor. In addition, signals, information, data, etc. generated from the memory and/or the processor may be transmitted to the vehicle and/or the driver and/or passengers.

The processor may perform vehicle control operations according to embodiments based on data and/or instructions stored in the memory.

The vehicle control device of FIG. 3 may correspond to a device mounted in a vehicle or a terminal device that controls the vehicle.

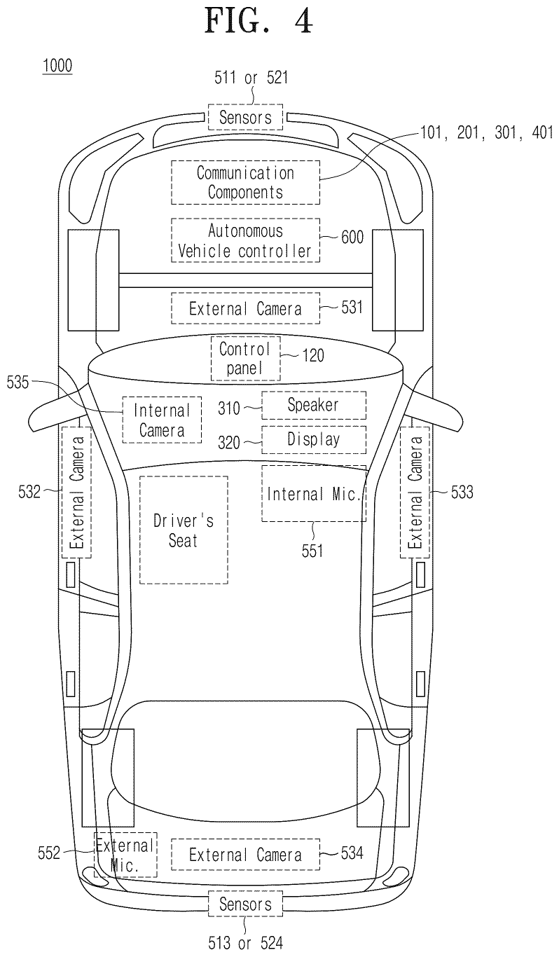

FIG. 4 illustrates a structure of a vehicle according to embodiments.

The vehicle according to embodiments may be configured as illustrated in FIG. 4 and may perform autonomous driving using an autonomous driving control system. The vehicle according to embodiments may be referred to as an autonomous vehicle, a robot, urban air mobility (UAM) aircraft, an autonomous driving device, etc.

An autonomous vehicle 1000 may be implemented around the autonomous driving integrated controller 600 that transmits and receives data required for autonomous driving control of the vehicle through a driving information input interface 101, a traveling information input interface 201, a passenger output interface 301, and a vehicle control output interface 401. However, the autonomous driving integrated controller may be referred to as a controller, a processor, or simply a controller in this specification.

The autonomous driving integrated controller may acquire driving information according to operation of a passenger for a user input unit in an autonomous driving mode or a manual driving mode of the vehicle through the driving information input interface. The user input unit may include a driving mode switch and a control panel 120 (for example, a navigation terminal mounted in the vehicle, a smartphone or a tablet computer carried by the passenger, etc.), and accordingly, the driving information may include driving mode information and navigation information of the vehicle.

In addition, upon determining that a warning is necessary to the driver in the autonomous driving mode or the manual driving mode of the vehicle, the autonomous driving integrated controller may provide warning information to the driver through the passenger output interface along with traveling state information. A speaker 310 and a display device 320 may be included to output such traveling state information and warning information audibly and visually. In this instance, the display device may be implemented as the same device as the control panel described above, or may be implemented as a separate and independent device.

In addition, the autonomous driving integrated controller may transmit control information for driving control of the vehicle to a sub-control system applied to the vehicle through the vehicle control output interface in the autonomous driving mode or the manual driving mode of the vehicle. The sub-control system for driving control of the vehicle may include at least one of a motor control system, an engine control system, a braking control system, or a steering control system, and the autonomous driving integrated controller may transmit at least one of motor control information, engine control information, braking control information, or steering control information as control information to each sub-control system through the vehicle control output interface.

The autonomous driving integrated controller may acquire driving information according to operation of the driver and traveling information indicating a traveling state of the vehicle through the driving information input interface and a traveling information input interface, respectively, and provide traveling state information and warning information generated according to an autonomous driving algorithm through the passenger output interface.

Meanwhile, to ensure stable autonomous driving of the vehicle, the autonomous driving device according to embodiments may include a sensor unit to detect objects around the vehicle, such as surrounding vehicles, pedestrians, roads, or fixed facilities (for example, traffic lights, signposts, traffic signs, construction fences, etc.).

The sensor unit may include one or more of a LiDAR sensor, a radar sensor, and a camera sensor to detect surrounding objects outside the vehicle. It is possible to include a front LiDAR sensor 511, a front radar sensor 521, a rear LiDAR sensor 513, a rear radar sensor 524, a left camera sensor 532, a right camera sensor 533, an internal camera sensor 535, a front camera sensor 531, a rear camera sensor 534, etc. The sensor unit may be connected to microphones 551 and 552.

The embodiments relate to a method of controlling driving of an ADS vehicle to an EV charging station by the AVDS.

The embodiments relate to international standards ISO 23374-1 (AVPS) and ISO 12768-1 (AVDS). The embodiments relate to an automated valet parking system (hereinafter referred to as “AVPS”) or an automated valet driving system (hereinafter referred to as “AVDS”). The embodiments provide a method and apparatus in which the ADS vehicle (conceptually the same concept as a standard “SV”) is autonomously driven from a parking position to an EV charging station and charged with electricity and returns back to the parking position or is headed to another position through autonomous driving after completion of charging.

The current international standard ISO 23374-1 or ISO 12768-1 merely describes a method/apparatus for moving the ADS vehicle to the EV charging station immediately after the EV charging station is vacated in response to completion of charging of a previous EV when the AVPS or AVDS sends the ADS vehicle to the EV charging station. However, the current international standard fails to define a method/apparatus for sending the ADS vehicle to the EV charging station before completion of charging of the previous EV in consideration of a charging completion time of the previous EV. Therefore, the embodiments describe a method/apparatus for driving the ADS vehicle in advance before completion of charging of the EV in consideration of the charging completion time of the previous EV to achieve efficient and safe automated valet driving. Accordingly, the embodiments have an effect of increasing efficiency of a charging service provided by the EV charging station since a return time of the ADS vehicle may be advanced.

The embodiments related to a method of exchanging data with the EV charging station using the AVDS.

The embodiments relate to international standards ISO 23374-1 (AVPS) and ISO 12768-1 (AVDS). The embodiments relate to an automated valet parking system (hereinafter referred to as “AVPS”) or an automated valet driving system (hereinafter referred to as “AVDS”). The embodiments provide a method and apparatus in which the ADS vehicle (used as the same concept as a standard “subject vehicle (SV)”) is autonomously driven from a parking position to an EV charging station and charged with electricity and returns back to the parking position or is headed to another position through autonomous driving after completion of charging.

The current international standard ISO 23374-1 or ISO 12768-1 fails to define data exchanged between the AVPS or the AVDS and the EV charging station. Therefore, the embodiments provide data exchanged between the AVPS or the AVDS and the EV charging station to achieve efficient and safe automated valet driving. Hereinafter, a description will be given of data used for mutual communication between the AVDS and the EV charging station according to embodiments. As a result, the embodiments have an effect of providing an efficient communication data protocol between the AVDS and the EV charging station.

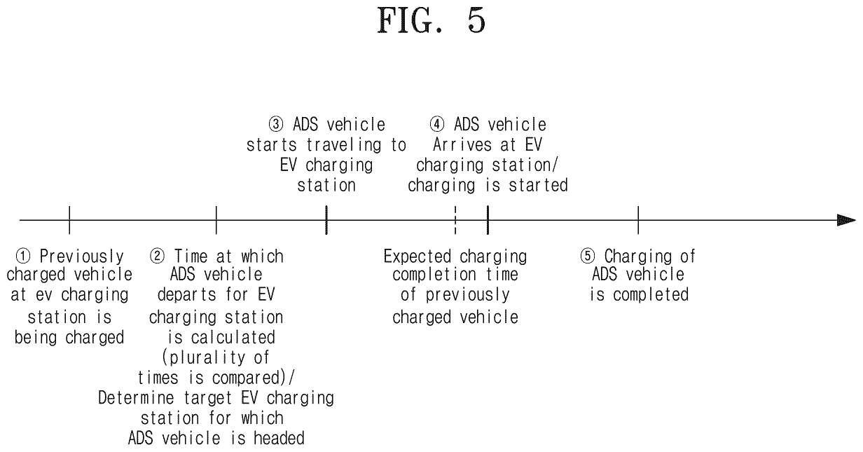

FIG. 5 illustrates a timeline of traveling of an AVDS vehicle to an EV charging station according to embodiments.

FIG. 5 illustrate in detail a method of performing the basic flow of the AVDS of FIG. 1. A driver of FIG. 5 corresponds to the user of FIG. 1, the UF and the UB of FIG. 2, etc. An ADS vehicle of FIG. 5 is a vehicle equipped with the AVDS, the AVDS corresponds to the system of FIG. 1, the OS, the OB, and the RO of FIG. 2, the processor of FIG. 3, etc., and the vehicle corresponds to the VB and the VO of FIG. 2, the processor of FIG. 3, the vehicle of FIG. 4, etc.

When a previously charged vehicle at the charging station (for example, the EV charging station) is being charged (step 1), the AVDS of the method/apparatus according to embodiments may start in advance traveling of the AVD vehicle to the charging station before charging of the previously charged vehicle is completed (step 3). When traveling of the ADS vehicle to the charging station is started in advance, the AVDS of the method/apparatus according to embodiments may determine a traveling start time of the ADS vehicle (described in detail below) based on an expected charging completion time of the previously charged vehicle.

The AVDS of the method/apparatus according to embodiments may determine a charging station (hereinafter, target charging station), which is a traveling destination of the ADS vehicle, from at least one charging station (step 2). The AVDS of the method/apparatus according to embodiments may receive information according to embodiments from the at least one charging station. The AVDS of the method/apparatus according to embodiments may calculate a reference value according to embodiments based on the information, and may determine a target charging station among the at least one charging station based on the reference value. In this instance, the at least one charging station may be all charging stations located within a certain distance from the ADS vehicle or all charging stations located in a specific facility (for example, an airport, a rental car company site, etc.).

In addition, the AVDS of the method/apparatus according to embodiments may request information according to embodiments from the at least one charging station upon receiving an EV charging reservation request from a user (or driver). Further, the AVDS may receive information from the at least one charging station receiving the request.

The information according to embodiments is as follows.

The information received by the AVDS of the method/apparatus according to embodiments from the at least one charging station may be charging progress or reservation status information of each charging station. For example, the information according to embodiments may include at least one selected from the group consisting of information on expected charging completion times of vehicles currently being charged or reserved for charging at each charging station, information on whether the AVDS is used for these vehicles, provided EV charging type information (for example, AC/DC, AC 5-pin type, etc.), charging rate information, and/or charging time information.

The reference value according to embodiments is as follows.

The AVDS of the method/apparatus according to embodiments may calculate the reference value based on the information received from at least one charging station, and determine a target charging station among the at least one charging station based on the reference value. For example, the reference value according to embodiments may include at least one selected from the group consisting of an expected return time of the ADS vehicle for each charging station, an expected rate upon completion of charging, and/or an expected time at which the ADS vehicle arrives at the charging station. In other words, the AVDS of the method/apparatus according to embodiments may determine the target charging station for the at least one charging station based on the reference value. For example, when the expected return time of the ADS vehicle for each charging station is greater than or equal to a reference value, the AVDS may determine a charging station that may return at an earlier time as the target charging station.

In this instance, the expected return time of the ADS vehicle is as follows.

The expected return time of the ADS vehicle may be calculated based on at least one selected from the group consisting of a time at which the ADS vehicle arrives at the target charging station, an expected time required for charging the ADS vehicle, and/or an expected time required for return of the ADS vehicle. In this instance, the time at which the ADS vehicle arrives at the target charging station may be the charging completion time of the previously charged vehicle or may be before the charging completion time of the previously charged vehicle, as will be described later. In addition, the expected time required for return of the ADS vehicle may be extracted based on traffic information in the corresponding timeslot.

The expected return time of the ADS vehicle may be calculated additionally based on a time taken for the previously charged vehicle to vacate an EV charging slot (hereinafter, charging area). More specifically, when the previously charged vehicle is the AVDS vehicle, the vehicle immediately moves, and thus it is preferable to additionally consider a time required to vacate the EV charging slot when the previously charged vehicle is a non-AVDS vehicle.

When the previously charged vehicle is the non-AVDS vehicle, it is possible to assume that the previously charged vehicle vacates the EV charging slot after a certain time. In this instance, the certain time may be an average value of data stored by the target charging station (for example, a time previously taken for non-AVDS vehicles to vacate the charging slot) or an average value of data for a specific vehicle type stored by the target charging station.

In addition, when the previously charged vehicle is the non-AVDS vehicle, the AVDS of the method/apparatus according to embodiments may exclude a charging station where the previously charged vehicle is located from the target charging station. In other words, when the AVDS determines that the previously charged vehicle located at the target charging station corresponds to a non-AVDS vehicle, the charging station may be excluded from the target charging station and a new target charging station may be determined again.

In addition, the AVDS of the method/apparatus according to embodiments may determine the target charging station based on the priority set in advance by the user (or driver). In this instance, the priority may be, but is not limited to, an expected rate upon completion of charging, a brand of each charging station, or an illuminance value when the ADS vehicle is moving.

For example, when the priority is an expected rate upon completion of charging, the AVDS may receive information only from charging stations corresponding to a rate range preset by the user (or driver) based on the rate rage to determine a target charging station therefrom, or calculate an expected return time of the ADS vehicle only for charging stations corresponding to the rate range to determine a target charging station. In other words, a final target charging station may be determined among charging stations corresponding to the rate range.

For example, when the priority is a brand for a specific charging station, the AVDS may receive information only from charging stations corresponding to a specific charging station brand preset by the user (or driver) due to various benefits (for example, card company linkage, etc.) based on the specific charging station brand to determine a target charging station therefrom, or calculate an expected return time of the ADS vehicle only for charging stations corresponding to this specific charging station brand to determine a target charging station. In other words, it is possible to determine a final target charging station among charging stations corresponding to a specific brand.

For example, when the priority is an illuminance value when the AVDS vehicle moves, the AVDS may exclude, from target charging stations, charging stations causing traveling at the illuminance value or less based the illuminance value preset by the user (or driver). In other words, when the user (or driver) sets the ADS vehicle not to travel at an illumination level less than or equal to a certain threshold, the AVDS may exclude charging stations causing traveling at an illumination level less than or equal to the threshold from target charging stations.

As described above, when traveling of the ADS vehicle to the charging station is started in advance, the AVDS of the method/apparatus according to embodiments may determine a traveling start time of the ADS vehicle based on the expected charging completion time of the previously charged vehicle.

The traveling start time may be derived based on an expected charging completion time of the previously charged vehicle calculated by the target charging station, a distance from a current location of the ADS vehicle to the target charging station calculated by the AVDS, and an expected average traveling speed or a maximum limit speed of the ADS vehicle calculated by the AVDS. More specifically, the traveling start time may be derived from a process of calculating the expected return time of the ADS vehicle described above.

In addition, the expected charging completion time of the previously charged vehicle, which is a basis for deriving the traveling start time, may be an expected charging completion time when charging of the previously charged vehicle is expected to be completed, or may be an earlier time. In other words, in the case of deriving the traveling start time of the ADS vehicle, when the arrival time is assumed to be a time when charging of the previous charging vehicle is completed, the traveling start time may be derived based on the expected charging completion time of the previous charging vehicle, and when the arrival time is assumed to be a time before completion of charging of the previously charged vehicle, the traveling start time may be derived based on a time which is a specific time earlier than the expected charging completion time of the previously charged vehicle.

Upon determining that the traveling start time is reached, the AVDS of the method/apparatus according to embodiments may drive the AVD vehicle to the target charging station (step 3). When the AVD vehicle arrives at (an operation zone or an ODD area of) the target charging station, the AVDS of the method/apparatus according to embodiments may transmit arrival information to the target charging station (step 4). The arrival information may include at least one selected from the group consisting of vehicle type information of the ADS vehicle, arrival time information at (the operation zone or the ODD area of) the target charging station of the ADS vehicle, and/or EV charging type information of the ADS vehicle.

In addition, the AVDS of the method/apparatus according to embodiments may drive the ADS vehicle to a waiting parking area when the ADS vehicle arrives at the target charging station before charging of the previously charged vehicle is completed, and may drive the ADS vehicle to a charging area when the ADS vehicle arrives at the target charging station after charging of the previously charged vehicle is completed.

In other words, when the AVDS drives the ADS vehicle in advance based on the expected charging completion time of the previously charged vehicle, the ADS vehicle may arrive at the target charging station i) before the charging completion time of the previously charged vehicle or ii) at or after the charging completion time of the previously charged vehicle. When the AVDS drives the ADS vehicle in advance based on a time earlier than the expected charging completion time of the previously charged vehicle, the ADS vehicle may be able to arrive at the target charging station i) before the charging completion time of the previously charged vehicle in most cases. Therefore, when the ADS vehicle arrives at the target charging station i) before the charging completion time of the previously charged vehicle, the ADS vehicle may be driven to the waiting parking area of the target charging station, and when the ADS vehicle arrives at the target charging station ii) at or after the charging completion time of the previously charged vehicle, the ADS vehicle may be driven to a charging area (EV charging slot, etc.) of the target charging station.

In addition, when the ADS vehicle is located at the waiting parking area at the charging completion time of the previously charged vehicle, the AVDS of the method/apparatus according to embodiments may move the ADS vehicle from the waiting parking area to the charging area. Upon determining that the ADS vehicle is out of the waiting parking area, the AVDS of the method/apparatus according to embodiments may transmit escape information to the target charging station. In this instance, the escape information may include at least one selected from the group consisting of an identification ID of the waiting parking area (for example, coded marker, identification umber, identification letter, etc.), a waiting parking area entry time of the ADS vehicle, and/or a target charging station management number of the ADS vehicle (identification number when an identification number of the ADS vehicle is assigned when entering the target charging station).

In addition, upon determining that the ADS vehicle is entering the charging area, the AVDS of the method/apparatus according to embodiments may transmit entry information to the target charging station. In this instance, the entry information may include at least one selected from the group consisting of an identification ID of the charging area (for example, coded marker, identification number, identification letter, etc.), a charging area entry time of the ADS vehicle, and/or a target charging station management number of the ADS vehicle (identification number when an identification number of the ADS vehicle is assigned when entering the target charging station). When charging of the ADS vehicle is completed, the AVDS of the method/apparatus according to embodiments may proceed with payment and return the ADS vehicle to an original location (step 5).

The charging area of the charging station may provide, for example, AC type, DC-combo type, magnetic induction type, or magnetic resonance type charging.

An AC type connector may be at least one of AC 5-pin or AC 7-pin. A DC-combo type connector may be at least one of combo 5-pin, combo 7-pin, or DC only (CHAdeMO).

Referring to FIG. 2, the automated valet driving method and device according to embodiments may be performed by an AVDS/server/processor such as the OS, the OB, the RO, etc. In addition, the method and device may be performed by a vehicle (on-board)/processor such as the VB and the VO. In addition, the method and device may be performed by a user interface (smartphone) such as the UF or the UB.

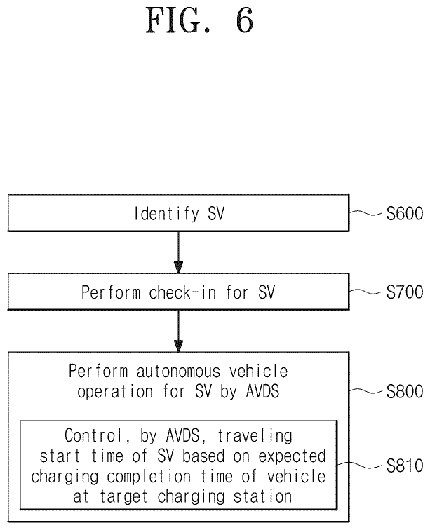

FIG. 6 illustrates an automated valet driving method according to embodiments.

FIG. 6 illustrates a method of performing automated valet driving based on a timeline as in FIG. 5 by the AVDS/server/processor of FIGS. 1 and 2, the processor of FIG. 3, the vehicle of FIG. 4, the autonomous driving controller of the vehicle of FIG. 4, etc.

The automated valet driving method according to the embodiments may include a step S600 of identifying an SV.

The automated valet driving method according to the embodiments may further include a step S700 of performing check-in for the SV.

The automated valet driving method according to the embodiments may further include a step S800 of performing an autonomous vehicle operation for the SV by the AVDS.

The step S800 of performing an autonomous vehicle operation for the SV may include a step S810 of controlling, by the AVDS, a traveling start time of the SV based on an expected charging completion time of the vehicle at the target charging station.

Referring to FIG. 6, the automated valet driving method may include a step S600 of identifying an SV, a step S700 of performing check-in for the SV, and a step S800 of performing an autonomous vehicle operation for the SV by the AVDS, and the step S800 of performing the autonomous vehicle operation for the SV by the AVDS may include a step S810 of controlling, by the AVDS, a traveling start time of the SV based on an expected charging completion time of the vehicle at the target charging station.

Hereinafter, a detailed description will be given of the step S800 of performing the autonomous vehicle operation for the SV by the AVDS.

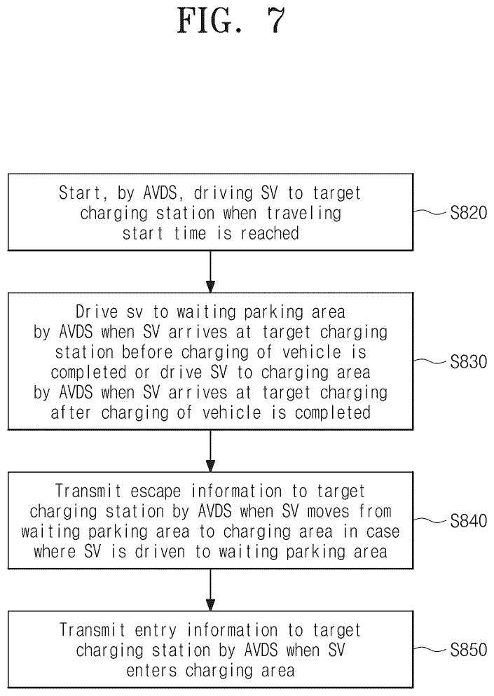

FIG. 7 illustrates an automated valet driving method according to other embodiments.

More specifically, FIG. 7 illustrates the step S800 of performing the autonomous vehicle operation for the SV in the automated valet driving method according to the embodiments of FIG. 6.

The step S800 of performing the autonomous vehicle operation for the SV may further include a step S820 of starting to drive the SV to the target charging station by the AVDS in response to the traveling start time being reached.

The step S800 of performing the autonomous vehicle operation for the SV may further include a step S830 of driving the SV to the waiting parking area by the AVDS when the SV arrives at the target charging station before charging of the vehicle is completed or driving the SV to the charging area by the AVDS when the SV arrives at the target charging station after charging of the vehicle is completed.

The step S800 of performing the autonomous vehicle operation for the SV may further include a step S840 of transmitting escape information to the target charging station by the AVDS when the SV moves from the waiting parking area to the charging area in the case where the SV is driven to the waiting parking area.

The step S800 of performing the autonomous vehicle operation for the SV may further include a step S850 of transmitting entry information to the target charging station by the AVDS when the SV enters the charging area.

Referring to FIG. 7, the step S800 of performing the autonomous vehicle operation for the SV may further include the step S820 of starting to drive the SV to the target charging station by the AVDS in response to the traveling start time being reached, and the traveling start time may be derived by the ADS based on an expected charging completion time or a time before the expected charging completion time.

The step S800 of performing the autonomous vehicle operation for the SV may further include the step S830 of driving the SV to the waiting parking area by the AVDS when the SV arrives at the target charging station before charging of the vehicle is completed or driving the SV to the charging area by the AVDS when the SV arrives at the target charging station after charging of the vehicle is completed.

The step S800 of performing the autonomous vehicle operation for the SV may further include the step S840 of transmitting escape information to the target charging station by the AVDS when the SV moves from the waiting parking area to the charging area in the case where the SV is driven to the waiting parking area, and the escape information may include at least one of an identification ID of the waiting parking area, a time at which the SV enters the waiting parking area, or a target charging station management number of the SV.

The step S800 of performing the autonomous vehicle operation for the SV may further include the step S850 of transmitting entry information to the target charging station by the AVDS when the SV enters the charging area, and the entry information may include at least one of an identification ID of the charging area, a time at which the SV enters the charging area, or a target charging station management number of the SV.

Hereinafter, a detailed description will be given of the step S810 of controlling the traveling start time of the SV.

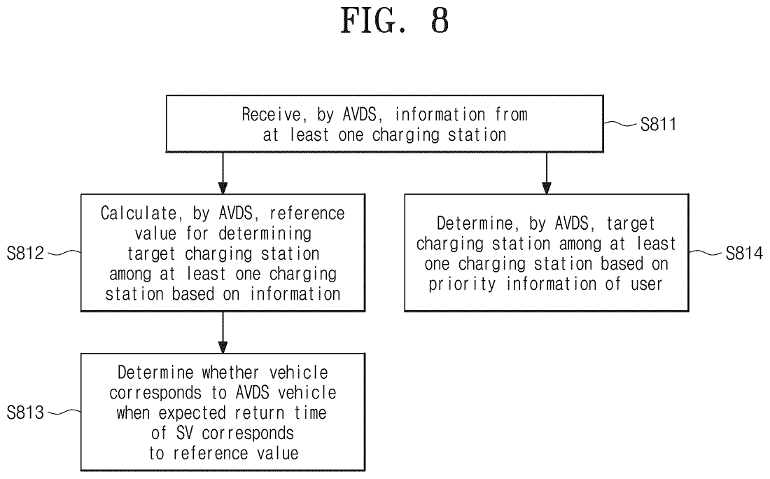

FIG. 8 illustrates an automated valet driving method according to still other embodiments.

More specifically, FIG. 8 illustrates the step S810 of controlling the traveling start time of the SV in the automated valet driving method according to the embodiments of FIG. 7.

The step S810 of controlling the traveling start time of the SV may include a step S811 of receiving, by the AVDS, information from the at least one charging station.

The step S810 of controlling the traveling start time of the SV may include a step S812 of calculating, by the AVDS, a reference value for determining a target charging station among the at least one charging station based on the information.

The step S810 of controlling the traveling start time of the SV may include a step S813 of determining whether the vehicle corresponds to the AVDS vehicle when the expected return time of the SV corresponds to a reference value.

The step S810 of controlling the traveling start time of the SV may include a step S814 of determining, by the AVDS, a target charging station among the at least one charging station based on priority information of the user.

Referring to FIG. 8, the step S810 of controlling the traveling start time of the SV may include the step S811 of receiving, by the AVDS, information from the at least one charging station, and the information may include at least one of charging time information, charging rate information, charging type information, or AVDS usage information of vehicles being charged or reversed for charging at the at least one charging station.

The at least one charging station may include at least one of at least one charging station located within a certain distance from the SV or at least one charging station located in a specific facility.

The step S810 of controlling the traveling start time of the SV may further include the step S812 of calculating, by the AVDS, a reference value for determining a target charging station among the at least one charging station based on the information, and the reference value may be at least one of an expected return time of the SV, an expected charging rate of the SV, or an expected time at which the SV arrives at the at least one charging station.

The step S810 of controlling the traveling start time of the SV may further include the step S813 of determining whether the vehicle corresponds to the AVDS vehicle when the expected return time of the SV corresponds to a reference value. When the vehicle corresponds to the AVDS vehicle, the AVDS may derive an expected return time of the SV based on at least one of a time at which the SV arrives at the target charging station, an expected charging time of the SV, or a return time of the SV. Alternatively, when the vehicle does not correspond to the AVDS vehicle, the AVDS derives the expected return time of the SV additionally based on a specific time required after charging of the vehicle is completed, and the specific time may be one of an average value of data stored by the target charging station or an average value of specific vehicle type data stored by the target charging station.

Alternatively, when the vehicle does not correspond to the AVDS vehicle, the AVDS may determine any one of the at least one charging station excluding the target charging station as a new target charging station. In other words, when the vehicle is a non-AVDS vehicle, the charging station where the vehicle is located may be excluded from the target charging station. In other words, upon determining that the vehicle located at the target charging station is a non-AVDS vehicle, the charging station may be excluded from the target charging station and a new target charging station may be determined again.

The step S810 of controlling the traveling start time of the SV may further include the step S814 of determining, by the AVDS, a target charging station among the at least one charging station based on priority information of the user, and the priority information may be one of charging rate information, brand information of the charging station, or illuminance information when the SV moves.

The automated valet driving method is performed by an automated valet driving device. Referring to FIGS. 2 and 3, the device includes a memory and a processor connected to the memory, and the processor may identify an SV, perform check-in for the SV, perform an autonomous vehicle operation for the SV by the AVDS, and control a traveling start time of the SV based on an expected charging completion time of the vehicle at the target charging station.

Referring to FIG. 4, a vehicle controlled by automated valet driving according to embodiments includes an interface configured to exchange information with the AVDS, and a controller configured to control automated valet driving, and the controller may identify an SV, perform check-in for the SV, perform an autonomous vehicle operation for the SV by the AVDS, and control a traveling start time of the SV based on an expected charging completion time of the vehicle at the target charging station. That is, traveling of the vehicle may be controlled based on the traveling start time determined by the AVDS.

Due to the embodiments, it is possible to efficiently define the expected charging completion time of the previously charged vehicle at the EV charging station. There is an effect of being able to advance the return time of the ADS vehicle by sending the ADS vehicle to the EV charging station before charging of the previously charged vehicle is completed based on this expected charging completion time.

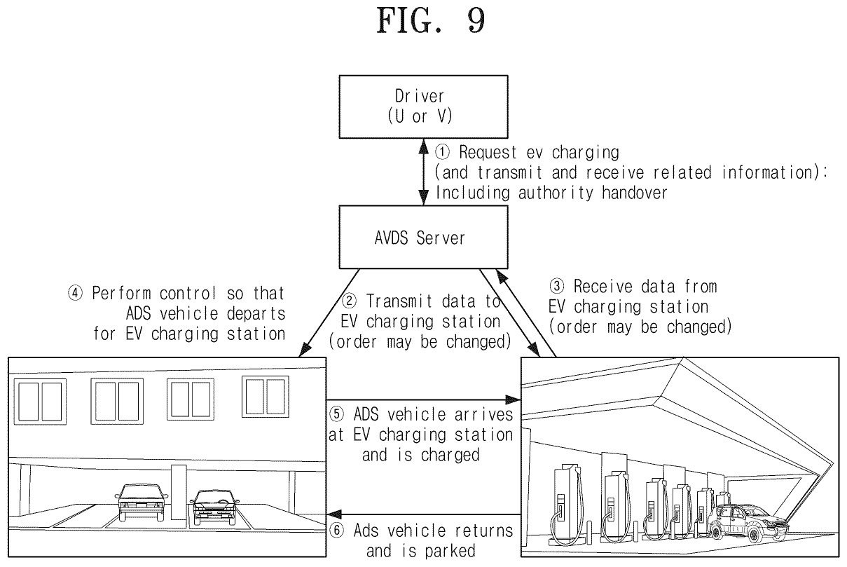

FIG. 9 illustrates an EV charging station based on the AVDS according to embodiments.

FIG. 9 illustrates in detail the system structure of FIG. 2 associated with the method and apparatus for performing the basic flow of the AVDS of FIG. 1. A driver of FIG. 9 corresponds to the user of FIG. 1, the UF and UB of FIG. 2, etc. The AVDS (server) of FIG. 9 corresponds to the system of FIG. 1, the OS, the OB, and the RO of FIG. 2, the processor of FIG. 3, etc. The vehicle of FIG. 9 corresponds to the VB and the VO of FIG. 2, the processor of FIG. 3, the vehicle of FIG. 4, etc.

The system of FIG. 9 includes a user, an AVDS system (for example, a server), a parking area, and/or a charging station.

The AVDS of the method/apparatus according to embodiments may receive an EV charging request from the user (or driver) (step 1). The AVDS of the method/apparatus according to embodiments may receive EV charging-related information from the user. The AVDS of the method/apparatus according to embodiments may request the EV charging-related information from the user, and receive a response. The AVDS of the method/apparatus according to embodiments may receive authority (handover) from the user.

The AVDS of the method/apparatus according to embodiments may transmit data (described in detail below) according to embodiments to the charging station (for example, EV charging station) (step 2). The AVDS of the method/apparatus according to embodiments may receive data from the charging station (step 3). Data transmitted and received between the charging station and the AVDS of the method/apparatus according to embodiments may include EV-related information and/or AVDS information.

The AVDS of the method/apparatus according to embodiments may control the ADS vehicle so that the ADS vehicle departs for the EV charging station (step 4). The vehicle may autonomously move from the parking area to the charging station area under the control of the AVDS of the method/apparatus according to embodiments. Under the control of the AVDS of the method/apparatus according to embodiments, the ADS vehicle may arrive at the EV charging station and start charging (step 5). When charging of the ADS vehicle is completed, the ADS vehicle may return to the parking area and perform autonomous parking under the control of the AVDS of the method/apparatus according to embodiments (step 6). The order of steps 2 and 3 may be varied. Furthermore, the order of steps 1 to 6 is an example, and detailed step operations may be changed according to an AVDS procedure.

Data transmitted and received between the AVDS and the EV charging station according to embodiments is as follows.

When allowing the ADS vehicle to use the EV charging station based on the AVDS, the AVDS needs to exchange key data with the EV charging station through mutual communication. “Transmitting data to the EV charging station (step 2)” and “receiving data from the EV charging station (step 3)” correspond thereto. Embodiments include a data system in which the AVDS and the EV charging station communicate with each other.

The method/apparatus according to embodiments includes a step of transmitting data by the AVDS. For example, this is an example of performing step 2 first.

The data transmitted by the AVDS to the EV charging station (data transmission to the EV charging station, step 2) includes the following.

As data transmission, the AVDS may transmit information including at least one of ADS vehicle information, EV charging reservation information, ADS vehicle departure information, or payment schedule type information to the EV charging station.

As a data request, the AVDS may generate information including at least one of an EV charging type provision availability information request, an EV charging reservation availability information request, or an EV charging rate information request, and transmit the information to the EV charging station.

Data transmitted by the EV charging station to the AVDS (receiving data from the EV charging station, step 3) includes the following.

As data transmission (respond), the AVDS may receive information including at least one of EV charging type provision availability information, EV charging reservation availability information, or EV charging rate information from the EV charging station.

The method/apparatus according to embodiments includes a step of transmitting data to the AVDS by the EV charging station. For example, this is an example of performing step 3 first. For example, the data transmission process of the EV charging station may be periodically performed.

Data transmitted by the EV charging station to the AVDS (receiving data from the EV charging station, step 2) includes the following.

As data transmission, the AVDS may receive data including at least one of (currently) available EV charging type information, EV charging reservation status information, or EV charging rate information from the EV charging station.

The data transmitted by the AVDS to the EV charging station (data transmission to the EV charging station, step 2) includes the following.

As data transmission (confirmation), the AVDS may generate data including at least one of ADS vehicle information, EV charging reservation confirmation information, expected ADS vehicle arrival time information, or payment method information/payment information and transmit the data to the EV charging station.

The apparatus/method according to embodiments, for example, the AVDS (see FIGS. 1 and 2) or the AVDS according to the processor (see FIG. 3) configured to control the AVDS may transmit data first. In other words, the data transmitted by the AVDS to the EV charging station (data transmission to the EV charging station, step 2) is as follows.

Hereinafter, a case in which AVDS transmits data first will be described.

The data transmitted by the AVDS to the EV charging station (data transmission to the EV charging station, step 2) is as follows.

ADS vehicle information according to embodiments is as follows.

For example, the ADS vehicle information may selectively include at least one selected from the group consisting of vehicle type information, vehicle size information (optional), EV charging type information available to the ADS vehicle, or EV charging pass (whether prepaid or not) information for the ADS vehicle.

The vehicle type information may include at least one selected from the group consisting of ADS vehicle manufacturer information, vehicle model information, or vehicle year information.

The vehicle size information may not be necessarily signaled since the vehicle size may be derived based on the vehicle type information according to embodiments. However, depending on the case, the vehicle size information may be necessary, and thus embodiments do not exclude an example in which the vehicle size information is included in the ADS vehicle information. The vehicle size information according to embodiments may include, for example, at least one selected from the group consisting of vehicle length (frontmost and rearmost lengths of the vehicle) information, vehicle width (left-right width of the vehicle) information, or vehicle height (ground-vehicle top height) information.

For example, the EV charging type information available to the ADS vehicle may include at least one selected from the group consisting of conductive charging/inductive charging instruction information, AC type/DC-combo type instruction information during conductive charging, connection plug instruction information in the AC type, connection plug instruction in the DC-combo type, and detailed charging type instruction information during inductive charging (for example, a magnetic induction method and a magnetic resonance method).

The EV charging pass (whether prepaid or not) information for the ADS vehicle may include at least one selected from the group consisting of information indicating whether to hold an EV charging pass, an EV charging pass target (for example, Company H EV charging pass, etc.), and a pass type (for example, fast/slow charging voucher, conductive/inductive charging voucher, AC/DC charging voucher, etc.).

A data structure of the ADS vehicle information according to embodiments is as follows.

ADS vehicle information

| Data item | Range | | Description |
|---|---|---|---|
| Vehicle type | 1. | ADS vehicle | To specify the current |
| information | | manufacturer | condition of the ADS |
| | | information | vehicle |
| | 2. | Vehicle model name | |
| | 3. | Vehicle model year | |
| Vehicle size | 1. | Length | Optional. Can be derived |
| information | 2. | Width | by the vehicle type |
| | 3. | Height | information in most cases |
| EV charging type | To be described in the next slide | | |
| available to the | | | |
| ADS vehicle | | | |
| EV charging season | 1. | Information | Periodical update needed |
| ticket (pre-payment) | | indicating whether | |
| information | | the right exist | |
| | 2. | Information on | |
| | | where to use the | |
| | | right | |
| | 3. | Type of the right | |

A data structure of the EV charging type information available to the ADS vehicle is as follows.

EV charging type available to the ADS vehicle

| Data item | | | Range | Description |
|---|---|---|---|---|
| EV charging type | | | 1. Conductive | |
| (conductive/inductive) | | | 2. Inductive | |
| | | | 3. Both | |
| 1/3 | Further classification below | | 1. AC type | The range can be substituted by |
| | conductive type | | 2. DC-combo type | <1. fast charging/2. slow |
| | | | | charging> |
| 1/3 | 1 | Further classification | 1. AC 5-pin | Represent connection plugs for |
| | | below AC type (see | 2. AC 7-pin | the AC type |
| | | IEC 62196-2) | | |
| 1/3 | 2 | Further classification | 1. Combo 5-pin | Represent connection plugs for |
| | | below DC-combo | 2. Combo 7-pin | the DC-combo type |
| | | type (see IEC 62196- | 3. DC only | |
| | | 3) | (CHAdeMO) | |

| | | |
|---|---|---|
| 2/3 | Further classification below | 1. Magnetic induction |
| | inductive type | 2. Magnetic resonance |

Depending on embodiments, data signaling of lower-level data not selected from upper-level data (for example, when the EV charging type is determined to be conductive, inductive is not selected) may be omitted (for example, null), or data indicating not being selected (for example, 3. No need to determine) may be signaled.

EV charging reservation information according to embodiments is as follows.

The EV charging reservation information relates to desired reservation time (range) information of the driver (user), and may only include i) desired reservation time (range) information in a first example or may include at least one selected from the group consisting of charging type priority information and desired reservation time (range) information for each priority in a second example.

In the first example, the desired reservation time (range) information may include start time information and end time information of a desired time range.

In the second example, for example, the charging type priority information may include Conductive-AC type-AC 5 pin as first priority, Inductive-Magnetic induction as second priority, and Conductive-DC type-combo 5 pin as third priority (that is, according to user preference, a charging time, etc.). For example, the desired reservation time (range) information for each priority may include an A time range as first priority, a B time range as second priority, and a C time range as third priority (here, A time range D∪B time range D∪C time range).

The ADS vehicle departure information according to embodiments is as follows.

The ADS vehicle departure information may include information on a time at which the ADS vehicle may depart (and information on a departure location of the ADS vehicle).

The payment schedule type information according to embodiments is as follows.

The payment schedule type information may indicate the means of paying for EV charging costs. Examples of a payment method may include EV-based payment (for example, ETCS, UWB payment, vehicle license plate recognition payment, etc.), credit card, various SNS pay (for example, N Pay, etc.), etc.

The method/apparatus according to embodiments may request the EV charging type provision availability information.

The EV charging type provision availability information indicates information on whether the EV charging station provides an EV charging type applicable to the ADS vehicle.

As a first example, Y (yes) may be signaled when at least one EV charging type is provided, and N (no) may be signaled when none is provided.

As a second example, all applicable EV charging types may be included (for example, signaling that Conductive AC 5 pin and Inductive Magnetic Induction may be applied to the ADS vehicle).

The method/apparatus according to embodiments may request the EV charging reservation availability information.

With regard to the first example of the above-described EV charging reservation information, the EV charging reservation availability information may include Y when reservation is possible in the desired time range, and N when reservation is impossible in the desired time range.

With regard to the second example of the above-described EV charging reservation information, the EV charging reservation availability information may include at least one selected from the group consisting of first priority reservation availability information, second priority reservation availability information, and third priority reservation availability information.

The method/apparatus according to embodiments may request EV charging rate information.

The EV charging rate information may indicate, for example, a charging rate per 1 kWh.

An example of data collection transmitted by the AVDS to the EV charging station (excluding ADS vehicle information) is as follows.

ADS vehicle information

| Data item | Range | | Description |
|---|---|---|---|
| EV charging reservation | 1. | Start time point of desired | Desired reservation time rage |
| information | | reservation time range | |
| | 2. | End time point of desired | |
| | | reservation time range | |
| ADS vehicle departure | 1. | Time point when the ADS | |
| information | | can depart | |
| | 2. | ADS vehicle departure | |
| | | location | |
| Expected payment type | 1. | EV based payment | Can be varied according to |
| information | 2. | Credit card | standard payment type at each |
| | 3. | SNS pay | time |
| EV charging type | 1. | Y | Alternatively, the range may |
| availability information | 2. | N | include all available EV |
| request | | | charging types |
| EV charging reservation | 1. | Y | Indicate whether the |
| availability request | 2. | N | reservation is available among |
| | | | the desired reservation time |
| | | | range. |
| EV charging rate | 1. | EV charging rate | For example, EV charging rate |
| information request | | | per 1 kWh |

In the case where the AVDS transmits data first, data transmitted by the EV charging station to the AVDS (data reception from the EV charging station, step 3) is as follows.

The method/apparatus according to embodiments may receive the LV charging type provision availability information.

The EV charging type provision availability information indicates information on whether the EV charging station provides an EV charging type applicable to the ADS vehicle.

As a first example, Y may be signaled when at least one EV charging type is provided, and N may be signaled when none is provided.

As a second example all applicable EV charging types may be included (for example, signaling that Conductive AC 5 pin and Inductive Magnetic Induction may be applied to the ADS vehicle).

The method/apparatus according to embodiments may receive the EV charging reservation availability information.

With regard to the first example of the above-described EV charging reservation information, the EV charging reservation availability information may include Y when reservation is possible in the desired time range, and N when reservation is impossible in the desired time range.

With regard to the second example of the above-described EV charging reservation information, the EV charging reservation availability information may include at least one selected from the group consisting of first priority reservation availability information, second priority reservation availability information, and third priority reservation availability information.

The method/apparatus according to embodiments may receive EV charging rate information.

The EV charging rate information may indicate, for example, a charging rate per 1 kWh.

Hereinafter, a description will be given of the case in which the EV charging station transmits data first (or periodically).

The data transmitted by the EV charging station to the AVDS (data reception from the EV charging station, step 3) is as follows.

(Currently) available EV charging type information according to embodiments is as follows.

The (currently) available EV charging type information may include all EV charging types that may be currently provided by the EV charging station (for example, signaling that Conductive AC 5 pin and Inductive Magnetic Induction may be provided).

EV charging reservation status information according to embodiments is as follows.

The EV charging reservation status information represents information including a reservation status by time of EV chargers at the EV charging station.

EV charging rate information according to embodiments is as follows.

The EV charging rate information may indicate, for example, a charging rate per 1 kWh.

In the case where the EV charging station transmits data first (or periodically), data transmitted by the AVDS to the EV charging station (data transmission to the EV charging station, step 2) is as follows.

EV charging reservation confirmation information according to embodiments is as follows.

The EV charging reservation confirmation information may include at least one selected from the group consisting of a confirmation/non-confirmation indication flag (Y/N), selected EV charging type information, and selected reservation slot information.

Expected arrival time information of the ADS vehicle according to embodiments is as follows.

The expected arrival time information of the ADS vehicle indicates time information that the AVDS expects the ADS to arrive at the EV charging station.

The AVDS may calculate an expected arrival time of the ADS vehicle using a navigation function, based on departure time information and a departure location of the ADS vehicle.

Payment method information/payment information according to embodiments is as follows.

The payment method information may indicate a confirmed payment method used for payment or pre-payment after the driver (user) arrives at the EV charging station and charges the EV.

The payment information may indicate information (for example, ID information, credit card number, vehicle license plate number, etc.) required for payment using the above payment method.

The ADS vehicle information according to embodiments is understood with reference to the ADS vehicle information, the data structure of the ADS vehicle information, and/or the data structure of the EV charging type information available to the ADS vehicle.

Referring to FIG. 2, the automated valet driving method and device according to embodiments may be performed by the AVDS/server/processor such as the OS, the OB, the RO, etc. In addition, the automated valet driving method and device may be performed by a vehicle (on-board)/processors such as the VB and the VO. In addition, the automated valet driving method and device may be performed by a user interface (smartphone) such as the UF or the UB.

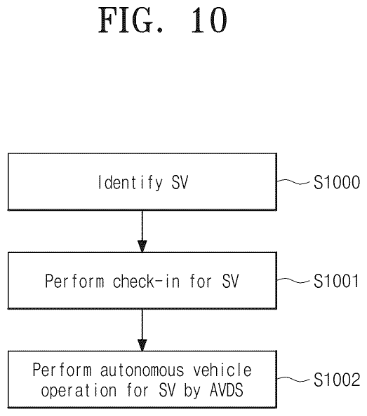

FIG. 10 illustrates an automated valet driving method according to embodiments.

FIG. 10 illustrates a method of performing automated valet driving according to embodiments by the AVDS/server/processor of FIGS. 1 and 2, the processor of FIG. 3, the vehicle of FIG. 4, an AVDS server of FIG. 9, etc.

The automated valet driving method according to embodiments may include a step S1000 of identifying an SV.

The automated valet driving method according to embodiments may further include a step S1001 of performing check-in for the SV.

The automated valet driving method according to embodiments may further include a step S1002 of performing an autonomous vehicle operation for the SV by the AVDS. To perform the autonomous vehicle operation, data according to embodiments is exchanged between the AVDS and the charging station.

Referring to FIG. 10, the automated valet driving method includes a step of identifying an SV, a step of performing check-in for the SV, and a step of performing an autonomous vehicle operation for the SV by the AVDS, and data for the autonomous vehicle operation may be transmitted and received by the AVDS.

In the case where the AVDS transmits data first, with regard to data transmitted by the AVDS to the EV charging station (data transmission to the EV charging station), the data transmitted by AVDS may include at least one of vehicle information for SV, charging reservation information, vehicle departure information, payment schedule type information, charging type availability information, charging reservation availability information, or charging rate information. The term “signal” may refer to data, information, etc. A step of transmitting and receiving a signal between the AVDS and the charging station describe the case where the AVDS transmits data (signals) first.

In the case where the AVDS transmits data first, with regard to data transmitted by the EV charging station to the AVDS (data reception from the EV charging station), the data received by AVDS may include at least one of charging type availability information, charging reservation availability information, or charging rate information. The term “signal” may separately refer to a first signal, a second signal, etc.

In the case where the EV charging station transmits data first (or periodically), with regard to data transmitted by the EV charging station to the AVDS (data reception from EV charging station), the data received by the AVDS may include at least one of currently available charging type information or charging rate information.

In the case where the EV charging station transmits data first (or periodically), with regard to data transmitted by the AVDS to the EV charging station (data transmission to the EV charging station), the data transmitted by the AVDS may include at least one of charging reservation confirmation information, expected vehicle arrival time information, payment method information, payment information, or vehicle information.

The automated valet driving method is performed by the automated valet driving device. Referring to FIGS. 2 and 3, the device includes a memory and a processor connected to the memory, the processor identifies an SV, performs check-in for the SV, and performs an autonomous vehicle operation for the SV by the AVDS, and data for the autonomous vehicle operation may be transmitted and received by the AVDS.

Referring to FIG. 4, the vehicle controlled by automated valet driving includes an interface configured to exchange information with the AVDS, and a controller configured to control automated valet driving (for example, the controller 600 of FIG. 4), the controller performs an autonomous vehicle operation for the SV by the AVDS, and automated valet driving may be performed based on data transmitted and received by the AVDS. That is, the vehicle may be controlled according to information and control of the AVDS.

Upon driver request, the AVDS may automatically drive the vehicle from a publicly available drop-off area in a mixed traffic environment to a charging station. After a charging operation is completed, the vehicle may return to a parking space when the driver is not present.

Since travel to and from the charging station is a short distance and does not disturb other road users, a maximum speed is limited to 10 km/h.

In the case of conductive charging using a robot, the AVDS may park the vehicle at the charging station with a charging socket facing a charging plug of the robot. A vehicle direction needs to be less than ±5° relative to a center line of a marked charging area and an outline of the parked vehicle is completely within an inner boundary of the parking space marking.

In the case of inductive charging, the system may park the vehicle in a charging space with a horizontal distance of ±5 cm between a center of a stationary coil and a center of a coil of the vehicle protruding from a road surface. An outline of the parked vehicle is completely within an inner boundary of the parking space marking. Data according to embodiments, which is additional means of the charging station (for example, an additional sensor or communication of a charging current optimization procedure), is used for a maneuver to reach this tolerance.

Due to the embodiments, a communication data protocol between the AVDS and the EV charging station may be efficiently defined. There is an effect in which the user, the AVDS, the charging station, the vehicle, etc. may perform automated valet driving accurately, safely, quickly, and efficiently based on this protocol.

The embodiments have been described in terms of a method and/or an apparatus, and the description of the method and the description of the apparatus may be applied to complement each other.

As described above, embodiments may be applied in whole or in part to the automated valet driving device and system.

The method/apparatus according to embodiments may efficiently perform automated valet driving of the vehicle.

The method/apparatus according to embodiments may safely perform automated valet driving of the vehicle.

The method/apparatus according to embodiments may accurately perform automated valet driving of the vehicle.

Various embodiments of the present disclosure do not list all available combinations but are for describing a representative aspect of the present disclosure, and descriptions of various embodiments may be applied independently or may be applied through a combination of two or more.

A number of embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A processor-implemented method, the method comprising:
identifying a subject vehicle (SV);
performing a check-in for the SV; and
performing an autonomous vehicle operation for the SV by an automated valet driving system (AVDS).

2. The method according to claim 1, wherein the performing the autonomous vehicle operation comprises:
calculating, by the AVDS, a traveling start time of the SV based on an expected charging completion time of a vehicle at a target charging station.

3. The method according to claim 2, wherein the calculating comprises:
receiving, by the AVDS, information from one or more charging stations; and
calculating, by the AVDS, a reference value for determining the target charging station from among the one or more charging stations based on the information,
wherein the information comprises one or more of charging time information, charging rate information, charging type information, and AVDS usage information of vehicles being charged or reserved for charging at the one or more charging stations, and
wherein the reference value is one or more of an expected return time of the SV, an expected charging rate of the SV, and an expected arrival time at which the SV arrives at the one or more charging stations.

4. The method according to claim 3, wherein the calculating further comprises determining whether the vehicle corresponds to an AVDS vehicle responsive to the expected return time of the SV corresponding to the reference value, and
wherein, when the vehicle corresponds to the AVDS vehicle, the AVDS calculates the expected return time of the SV based on one or more of a time at which the SV arrives at the target charging station, an expected charging time of the SV, and a return time of the SV.

5. The method according to claim 3, wherein the calculating further comprises determining, by the AVDS, the target charging station from among the one or more charging stations based on priority information of a user, and
wherein the priority information comprises one or more of charging rate information, charging station brand information, and illuminance information from when the SV moves.

6. The method according to claim 2, wherein the performing the autonomous vehicle operation further comprises initiating, by the AVDS, driving of the SV to the target charging station responsive to the traveling start time being reached, and
wherein the traveling start time is derived by the AVDS based on the expected charging completion time or a time before the expected charging completion time.

7. The method according to claim 6, wherein the performing the autonomous vehicle operation further comprises driving, by the AVDS, the SV to a waiting parking area responsive to the SV arriving at the target charging station before a charging of the vehicle is completed, or driving, by the AVDS, the SV to a charging area responsive to the SV arriving at the target charging station after charging of the vehicle is completed.

8. The method according to claim 7, wherein the performing the autonomous vehicle operation further comprises:
transmitting, by the AVDS, escape information to the target charging station responsive to the SV moving from the waiting parking area to the charging area responsive to the SV is in waiting parking area; and
transmitting, by the AVDS, entry information to the target charging station responsive to the SV entering the charging area,
wherein the escape information comprises one or more of an identification ID of the waiting parking area, a time at which the SV enters the waiting parking area, and a target charging station management number of the SV, and
wherein the entry information comprises one or more of an identification ID of the charging area, a time at which the SV enters the charging area, and the target charging station management number of the SV.

9. The method according to claim 1, further comprising:
transmitting and receiving data for the autonomous vehicle operation by the AVDS.

10. The method according to claim 9, wherein the data transmitted by the AVDS comprises one or more of vehicle information for the SV, charging reservation information, vehicle departure information, payment schedule type information, charging type availability information, charging reservation availability information, and charging rate information, and
wherein the data received by the AVDS comprises one or more of charging type availability information, charging reservation availability information, and charging rate information.

11. The method according to claim 9, wherein the data received by the AVDS comprises one or more of currently available charging type information, charging reservation information, and charging rate information, and
wherein the data transmitted by the AVDS comprises one or more of charging reservation confirmation information, expected vehicle arrival time information, payment method information, payment information, and vehicle information.

12. An automated valet driving device (AVDS), comprising:
a processor configured to execute instructions; and
a memory storing the instructions, wherein execution of the instructions configures the processor to:
identify an SV,
perform a check-in for the SV, and
perform an autonomous vehicle operation for the SV by the AVDS.

13. The automated valet driving device according to claim 12, wherein the autonomous vehicle operation comprises:
calculating a traveling start time of the SV based on an expected charging completion time of a vehicle at a target charging station; and
transmitting and receiving data for the autonomous vehicle operation by the AVDS.

14. A vehicle, comprising:
an interface configured to exchange information with an AVDS; and
a controller configured to control automated valet driving,
a processor, associated with the controller and interface, the processor being configured to execute instructions; and
a memory storing the instructions, wherein execution of the instructions configures the processor to:
perform an autonomous vehicle operation by the AVDS.

15. The vehicle according to claim 14, wherein the autonomous vehicle operation comprises:
calculating a traveling start time based on an expected charging completion time of a vehicle at a target charging station; and
performing automated valet driving according to data transmitted and received by the AVDS.
